(19) United States
(12) Patent Application Publication
(10) Pub. No.: US 2009/0267974 A1
(43) Pub. Date: Oct. 29, 2009

(54) METHOD FOR DRIVING PLASMA DISPLAY PANEL

(75) Inventors: Mitsushi Kitagawa, Chuo-shi (JP); Mitsuhiro Ishizuka, Chuo-shi (JP); Kazuo Yahagi, Chuo-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Tokyo (JP)

(21) Appl. No.: 12/193,207

(22) Filed: Aug. 18, 2008

(30) Foreign Application Priority Data
Apr. 25, 2008 (JP) 2008-115232

(51) Int. Cl. G09G 5/08; G09G 3/28

(52) U.S. Cl. 345/691; 345/208

(57) ABSTRACT

A plasma display device and a method for driving a Plasma Display Panel (PDP), which can reduce power consumption without causing display malfunction or reducing image quality, are provided. When the input of an image signal is stopped or when an input image signal is in an entirely-black image state, the application of a drive pulse for driving the PDP is stopped. Here, when the input of the image signal is resumed or when the input image signal switches from the entirely-black image state to a normal image state, the absolute value of a peak potential of the drive pulse or the pulse width thereof is increased to increase the strength of discharge until a predetermined period elapses after the resumption or switching and then the absolute value of a peak potential of the drive pulse or the pulse width is returned to a normal absolute value or a normal pulse width.

### BACKGROUND OF THE INVENTION

1. Field of the Invention

The present invention relates to a method for driving a plasma display panel.

2. Description of the Related Art

Currently, a plasma display device including a Plasma Display Panel (PDP), in which discharge cells corresponding to pixels are arranged in a matrix, is commercially available as a thin large-screen display device.

The PDP includes a front substrate serving as a display surface and a rear substrate with discharge gases being sealed in discharge spaces defined between the front and rear substrates. Pairs of row electrodes X and Y, which serve respectively as display lines of one screen, are arranged on the front substrate. Column electrodes are arranged, extending in a direction crossing the pairs of row electrodes, on the rear substrate. Discharge cells, each serving as a pixel, are formed in respective intersection portions between the pairs of row electrodes X and Y and the column electrodes.

In the plasma display device, various drive pulses described below are applied to the PDP having such a structure so that an image based on an image signal is displayed on the screen of the PDP.

First, a scan pulse is sequentially and selectively applied to each of the pairs of row electrodes X and Y and a pixel data pulse according to the image signal is applied to each of the column electrodes synchronously with the application of each scan pulse (addressing step). Accordingly, a discharge (addressing discharge) is generated in each discharge cell that is to be set to a light-on mode to create a desired amount of wall charges in the discharge cell. Each discharge cell in which no addressing discharge has been generated is maintained in a light-off mode since the amount of wall charges in the discharge cell is less than a desired amount. Then, sustain pulses are alternately and repeatedly applied to all row electrodes X and all row electrodes Y (sustain step). Here, each time a sustain pulse is applied, a discharge (sustain discharge) is generated in each discharge cell PC that is in a light-on mode so as to obtain luminance corresponding to the number of times the sustain discharge is generated.

However, the plasma display device has a problem of high power consumption since, when the PDP is driven, it is necessary not only to generate sustain discharges accompanied by light emission that serves to display an image but also to generate various other discharges.

Japanese Patent Application Publication No. 2002-311889 has suggested a drive method in which the generation of all drive pulses is forcibly stopped during a blanking interval and during a no-signal interval in order to reduce power consumption.

However, in the PDP, the number of priming particles remaining in each discharge cell decreases as the period during which the application of drive pulses is stopped increases. Thus, even though the application of drive pulses is resumed, it may be difficult to generate stable discharges, causing display malfunction and reducing image quality.

### SUMMARY OF THE INVENTION

Therefore, the present invention has been made in view of the above problems, and it is an object of the present invention to provide a method for driving a Plasma Display Panel (PDP) which can reduce power consumption without causing display malfunction or reducing image quality.

In accordance with one aspect of the present invention, the above and other objects can be accomplished by the provision of a method for driving a plasma display panel including a discharge cell corresponding to a pixel wherein a variety of drive pulses are applied to the plasma display panel to display an image represented by an input image signal, the method including applying a drive pulse having a first pulse waveform to the discharge cell in a period during which the image signal being input, and stopping the application of the drive pulse when the input of the image signal is stopped and thereafter applying, when the input of the image signal is resumed, the drive pulse having a second pulse waveform different from the first pulse waveform to the discharge cell during a predetermined period.

In accordance with another aspect of the present invention, the above and other objects can also be accomplished by the provision of a method for driving a plasma display panel including a discharge cell corresponding to a pixel wherein a variety of drive pulses are applied to the plasma display panel to display an image represented by an input image signal, the method including applying a drive pulse having a first pulse waveform to the discharge cell in a period during which an image signal representing a normal image, other than an entirely-black image that is an image of one frame entirely having a luminance level of “0”, is supplied, and stopping the application of the drive pulse when the image signal changes from a state representing the normal image to a state representing the entirely-black image and thereafter applying, when the image signal returns to the state representing the normal image, the drive pulse having a second pulse waveform different from the first pulse waveform to the discharge cell during a predetermined period.

When the input of an image signal is stopped or when an input image signal enters an entirely-black image state, the application of a drive pulse for driving the PDP is stopped to reduce power consumption. Here, when the input of an image signal is resumed or when the image signal returns from the entirely-black image to a normal image state, the absolute value of a peak potential of the drive pulse or the pulse width of the drive pulse is increased to a normal absolute value or a normal pulse width to increase the strength of discharge until a predetermined period elapses after resumption of image signal input. That is, after the application of the drive pulse is stopped, the number of priming particles remaining in the discharge cell decreases, thereby bringing the discharge cell into a state in which it is difficult to generate discharges. Thus, immediately after the input of an image signal is resumed or the image signal returns to a normal image state, the absolute value of a peak potential of each of the various drive pulses or the pulse width of each of the various drive pulses is increased during a predetermined period to increase the strength of discharge so that discharges are generated even though the number of priming particles remaining in the discharge cell is small. Due to discharges generated during this predetermined period, the number of priming particles is increased so that it is easy to generate discharges in the discharge cell and thus the absolute value of the peak potential of each of the various drive pulses or the pulse width of each of the various drive pulses is returned to a normal absolute value or a normal pulse width. According to this method, even though the application of the drive pulse is resumed after the application of the drive pulse is stopped to reduce power consumption, stable discharges can be generated immediately after the application of the drive pulse is resumed, and it is thus possible to reduce power consumption without causing display malfunction or reducing image quality.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a configuration of a plasma display device that drives a Plasma Display Panel (PDP) according to a drive method according to the invention;

FIG. 2 illustrates an operation of the plasma display device according to a reset mode (RM) set by a reset mode setting unit 2;

FIG. 3 illustrates an example of a light emission drive sequence when the PDP 10 shown in FIG. 1 is driven;

FIG. 4 illustrates the timings of application of various drive pulses to the PDP 10 in a subfield SF1 in a “normal mode”;

FIG. 5 illustrates an example of a reset pulse generation circuit included in a Y electrode driver 6;

FIG. 6 illustrates the timings of application of various drive pulses to the PDP 10 in a subfield SF1 in a “stop mode”;

FIG. 7 illustrates the timings of application of various drive pulses to the PDP 10 in a subfield SF1 in a “boost mode”;

FIG. 8 illustrates a first modification of the operation of the plasma display device shown in FIG. 2;

FIG. 9 illustrates a second modification of the operation of the plasma display device shown in FIG. 2;

FIG. 10 illustrates a third modification of the operation of the plasma display device shown in FIG. 2;

FIG. 11 illustrates a fourth modification of the operation of the plasma display device shown in FIG. 2;

FIG. 12 illustrates another configuration of a plasma display device that drives a PDP according to a drive method according to the invention;

FIG. 13 illustrates an operation of the plasma display device according to a reset mode (RM) set by a reset mode setting unit 20 shown in FIG. 12;

FIG. 14 illustrates a first modification of the operation of the plasma display device shown in FIG. 13;

FIG. 15 illustrates a second modification of the operation of the plasma display device shown in FIG. 13;

FIG. 16 illustrates a third modification of the operation of the plasma display device shown in FIG. 13;

FIG. 17 illustrates a fourth modification of the operation of the plasma display device shown in FIG. 13; and

FIG. 18 illustrates waveforms of a reset pulse RP_{Y} when a pulse width rather than a peak potential is increased in a “boost mode”.

### DETAILED DESCRIPTION OF THE PREFERRED EMBODIMENTS

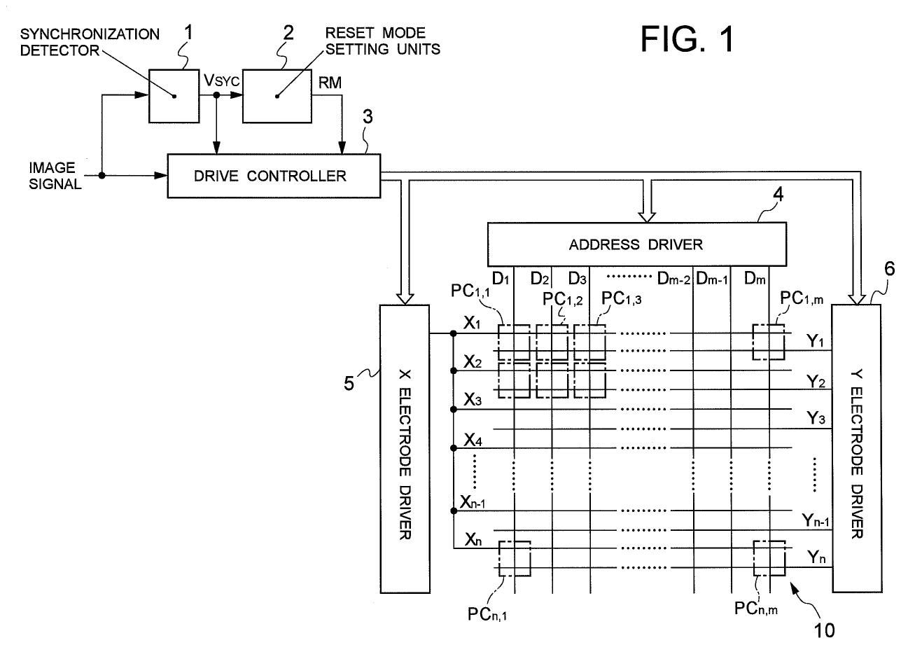

FIG. 1 illustrates a configuration of a plasma display device that drives a Plasma Display Panel (PDP) according to a drive method according to the invention.

As shown in FIG. 1, the plasma display device includes a PDP 10 that includes a front substrate (not shown) serving as a display surface and a rear substrate (not shown) with discharge gases being sealed in discharge spaces defined between the front and rear substrates. Row electrodes X₁ to Xₙ and row electrodes Y₁ to Yₙ are alternately arranged, extending in a horizontal direction of the 2D display screen, on the front substrate. A pair of neighboring row electrodes X and Y serves as one display line in the 2D display screen. Column electrodes D₁ to Dₘ are arranged, extending in a vertical direction of the 2D display screen, on the rear substrate such that the column electrodes D₁ to Dₘ cross the row electrodes X₁ to Xₙ and Y₁ to Yₙ as shown in FIG. 1. Here, one column electrode D serves as one column of the 2D display screen. Discharge cells PC, each serving as a pixel, are formed in respective intersection portions between the pairs of row electrodes X and Y and the column electrodes D. That is, n display lines (1st to nth display lines) are formed in the PDP 10 and m discharge cells PC are arranged in each of the n display lines. In addition, n discharge cells PC are arranged in each of the m columns of the PDP 10.

A synchronization detector 1 generates a synchronization detection signal V_{SYC} including pulses VP, each of which is created each time a vertical synchronization signal of a vertical period T_{V} is detected from an image signal, and supplies the synchronization detection signal V_{SYC} to a reset mode setting unit 2 and a drive controller 3.

The reset mode setting unit 2 generates a reset mode signal RM indicating one of “normal mode”, “stop mode”, and “boost mode” by performing processes described below based on the synchronization detection signal V_{SYC} and supplies the reset mode signal RM to the drive controller 3.

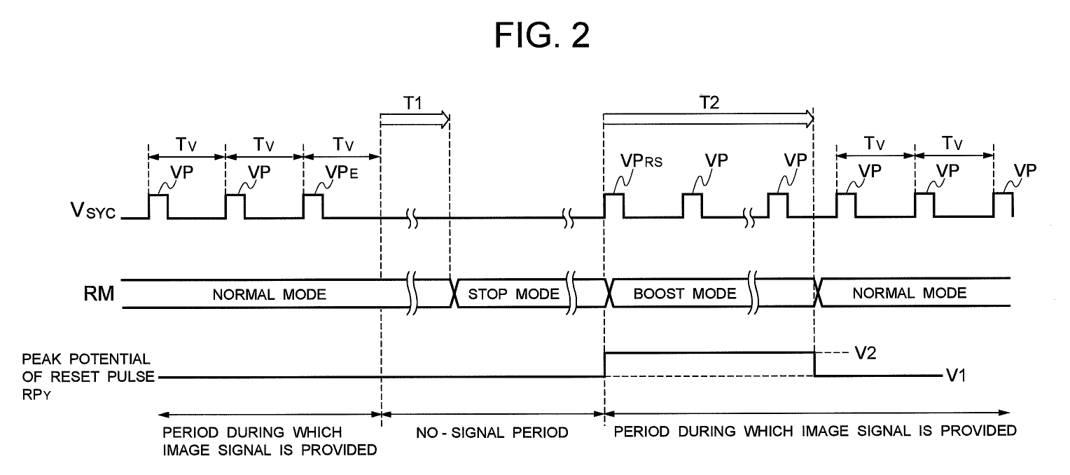

More specifically, the reset mode setting unit 2 supplies a reset mode signal RM indicating the normal mode to the drive controller 3 as shown in FIG. 2 in a period during which a pulse VP is detected from the synchronization detection signal V_{SYC} every vertical period T_{V}, i.e., in a period during which an image signal is supplied.

When the provision of an image signal is stopped in the normal mode, the reset mode setting unit 2 sequentially switches the reset mode from the normal mode to the stop mode and then from the stop mode to the boost mode according to a sequence as described below.

More specifically, if no next pulse VP is detected at the time when a vertical period T_{V} elapses after one pulse VP (denoted by “VP_{E}” in FIG. 2) is detected as shown in FIG. 2, the reset mode setting unit 2 determines whether or not a next pulse VP is detected until a predetermined first period T1 (T1>TV) elapses after the time when the vertical period T_{V} elapses, i.e., after the time when a next pulse VP should have been detected. Here, if no next pulse VP is detected, the reset mode setting unit 2 determines that the provision of an image signal is stopped and supplies a reset mode signal RM indicating the stop mode instead of the normal mode to the drive controller 3 at the time when the first period T1 elapses. That is, when a pulse VP indicating a vertical synchronization timing is not detected, i.e., when no image signal is supplied, the reset mode setting unit 2 supplies a reset mode signal RM indicating the stop mode to the drive controller 3. Thereafter, as shown in FIG. 2, when a first pulse VP (denoted by “VP_{RS}” in FIG. 2) is detected from the synchronization detection signal V_{SYC} as shown in FIG. 2, the reset mode setting unit 2 supplies a reset mode signal RM indicating the boost mode instead of the stop mode to the drive controller 3 during a predetermined second period T2. After the second period T2 elapses, the reset mode setting unit 2 supplies a reset mode signal RM indicating the normal mode to the drive controller 3. That is, when the provision of an image signal is resumed, the reset mode setting unit 2 does not immediately return to the normal mode but instead returns to the normal mode after setting the reset mode to the boost mode during the second period T2.

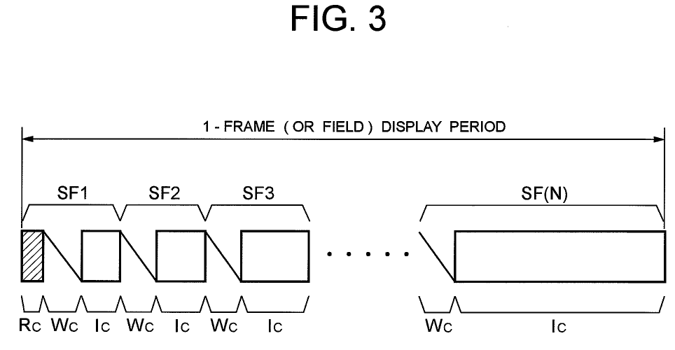

The drive controller 3 supplies various drive control signals for driving the PDP 10 to the panel driver including the addressing driver 4, the X electrode driver 5, and the Y electrode driver 6 according to a light emission drive sequence based on a subfield scheme as shown in FIG. 3. More specifically, during each 1-frame or 1-field display period (also referred to as a “unit display period”), the drive controller 3 supplies various control signals for sequentially performing drive operations according to an addressing step W_{C} and a sustain step I_{c} to the panel driver in each of subfields SF1 to SF(N). The drive controller 3 also supplies various control signals for performing a drive operation according to a reset step R_{C} prior to an addressing step W_{C} to the panel driver only in the first subfield SF1.

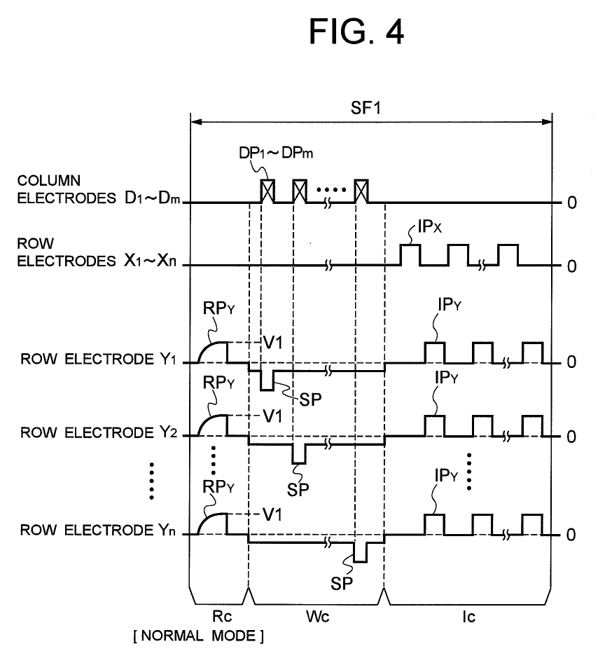

The panel driver including the addressing driver 4, the X electrode driver 5, and the Y electrode driver 6 applies various drive pulses to the column electrodes D and the row electrodes X and Y of the PDP 10 as shown in FIG. 4 in each of the reset step R_{C}, the addressing step W_{C}, and the sustain step I_{c} according to various control signals received from the drive controller 3. FIG. 4 illustrates how various drive pulses are applied in the first subfield SF1 among the subfields SF1 to SF(N) shown in FIG. 3.

As shown in FIG. 4, in the addressing step W_{C} of each subfield SF, the Y electrode driver 6 sets all row electrodes Y₁ to Yₙ to a predetermined negative potential and sequentially and selectively applies a scan pulse SP having a negative peak potential to each of the row electrodes Y₁, Y₂, Y₃, . . . , Yₙ₋₁, and Yₙ. During this procedure, in each of the subfields SF1 to SF(N), the drive controller 3 generates a pixel drive data bit for each discharge cell PC, indicating whether the discharge cell PC is to be set to a light-on mode or light-off mode in the subfield SF, based on a luminance level of each pixel represented by the image signal. For example, the drive controller 3 generates a pixel drive data bit having a logic level of “0” for each discharge cell PC that is to be set to a light-on mode and a pixel drive data bit having a logic level of “1” for each discharge cell PC that is to be set to a light-off mode. The drive controller 3 supplies such pixel drive data bits corresponding in number to one display line (i.e., m pixel drive data bits) to the addressing driver 4 synchronously with the application of each scan pulse SP. Then, the addressing driver 4 generates pixel data pulses DP₁ to DPₘ having respective peak potentials corresponding to the respective logic levels of the m pixel drive data bits and applies the pixel data pulses DP₁ to DPₘ to the column electrodes D₁ to Dₘ. For example, the addressing driver 4 generates a high-voltage pixel data pulse DP having a predetermined high positive peak potential in response to each pixel drive data bit DB having a logic level of “1”. On the other hand, the addressing driver 4 generates a low-voltage pixel data pulse DP having a predetermined low peak potential (for example, 0V) in response to each pixel drive data bit DB having a logic level of “0”. An addressing discharge is generated in each discharge cell PC, to which a high-voltage pixel data pulse DP has been applied simultaneously with the application of the scan pulse SP, thereby erasing wall charges remaining in the discharge cell PC. Accordingly, the state of the discharge cell PC changes from the light-on mode to the light-off mode. On the other hand, no addressing discharge is generated in each discharge cell PC, to which a low-voltage pixel data pulse DP has been applied simultaneously with the application of the scan pulse SP. Accordingly, the discharge cell PC is kept in the immediately previous state (light-on mode or light-off mode).

In the sustain step I_{c} of each subfield SF, the X electrode driver 5 and the Y electrode driver 6 alternately and repeatedly apply sustain pulses IP_{X} and IP_{Y} having a positive peak potential to the row electrodes X₁ to Xₙ and Y₁ to Yₙ a number of times corresponding to a luminance weight of the subfield. Each time the sustain pulses IP_{X} and IP_{Y} are applied, a sustain discharge is generated in each discharge cell PC which is in a light-on mode and the discharge cell PC is kept in a light emission state due to the sustain discharge. Thus, luminance corresponding to the total number of times the sustain discharge is generated in the unit display period is viewed.

In the reset step R_{C} that is performed only in the first subfield SF1 in the unit display period, the drive controller 3 supplies various drive control signals for generating reset pulses according to a mode indicated by the reset mode signal RM to the Y electrode driver 6.

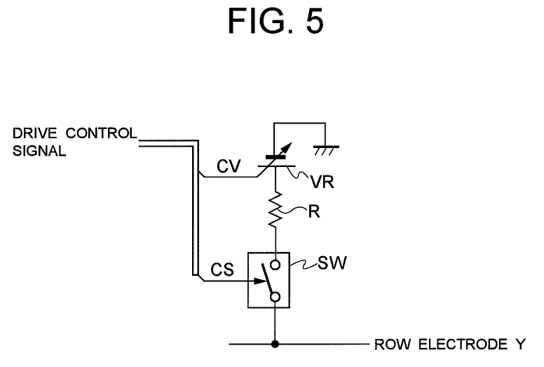

FIG. 5 illustrates a configuration of a reset pulse generation circuit provided in the Y electrode driver 6.

As shown in FIG. 5, a variable DC power source VR generates a DC voltage indicated by a peak potential setting signal CV as one of the drive control signals described above. A switching element SW is set to either an on or off state according to a switching signal CS as one of the drive control signals described above. A voltage on a positive terminal of the variable DC power source VR is applied to the row electrode Y via a resistor R only when the switching element SW is on.

Here, when the reset mode signal RM indicates the normal mode, the drive controller 3 supplies a peak potential setting signal CV for generating a potential V1 as a positive peak potential of a reset pulse to the reset pulse generation circuit. The drive controller 3 also supplies a switching signal CS for setting the switching element SW to an on state during a predetermined period to the reset pulse generation circuit. Accordingly, in the normal mode, the Y electrode driver 6 generates a reset pulse RP_{Y} having a waveform in which the potential of the reset pulse RP_{Y} gradually increases from 0V until reaching the positive peak potential V1 in the reset step R_{C} as shown in FIG. 4 and simultaneously applies the reset pulse RP_{Y} to all row electrodes Y₁ to Yₙ. In response to this reset pulse RP_{Y}, a reset discharge is generated in every discharge cell PC of the PDP 10, thereby creating a specific amount of wall charges in each discharge cell. This initializes every discharge cell PC to a light-on mode.

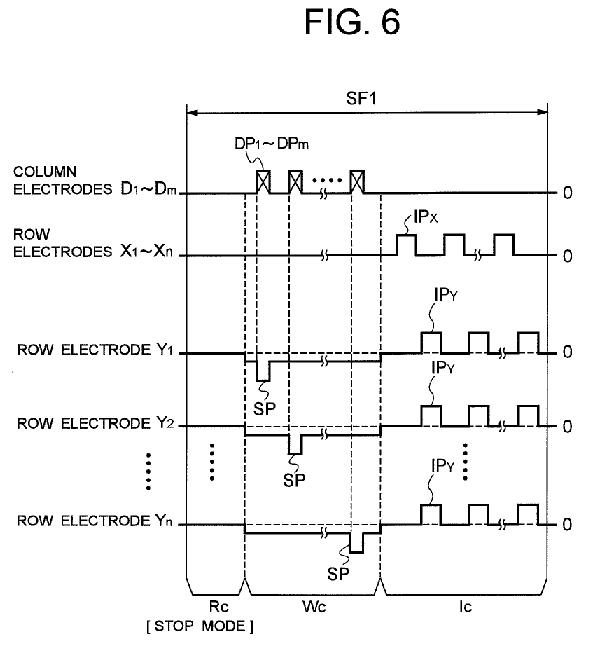

When the reset mode signal RM indicates the stop mode, the drive controller 3 supplies a switching signal CS for setting the switching element SW to an off state during the period of the reset step R_{C} to the reset pulse generation circuit. Accordingly, in the stop mode, the Y electrode driver 6 stops applying the reset pulse RP_{Y} as described above in the reset step R_{C} as shown in FIG. 6. Accordingly, the reset discharge for initializing the discharge cells is not generated in the stop mode.

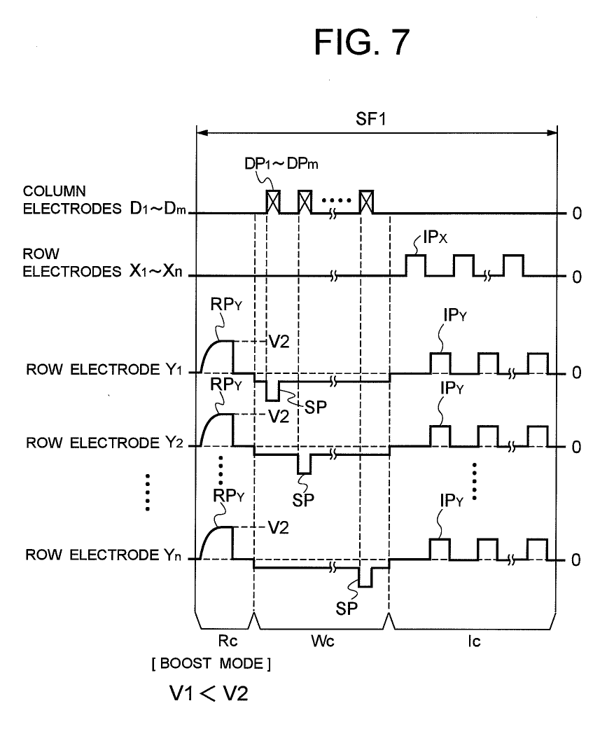

When the reset mode signal RM indicates the boost mode, the drive controller 3 supplies a peak potential setting signal CV for generating a potential V2 higher than the potential V1 as a positive peak potential of a reset pulse to the reset pulse generation circuit. The drive controller 3 also supplies a switching signal CS for setting the switching element SW to an on state during a predetermined period to the reset pulse generation circuit. Accordingly, in the boost mode, the Y electrode driver 6 generates a reset pulse RP_{Y} having a waveform in which the potential of the reset pulse RP_{Y} gradually increases from 0V until reaching the positive peak potential V2 (V1<V2) in the reset step R_{C} as shown in FIG. 7 and simultaneously applies the reset pulse RP_{Y} to all row electrodes Y₁ to Yₙ. In response to this reset pulse RP_{Y}, a reset discharge is generated in every discharge cell PC of the PDP 10, thereby creating a specific amount of wall charges in each discharge cell. This initializes every discharge cell PC to a light-on mode.

When the reset step R_{C} is performed every unit display period, the plasma display device shown in FIG. 1 is set to the normal mode during a period in which an image signal is supplied as shown in FIG. 2 and a reset discharge is generated in every discharge cell PC in response to the reset pulse RP_{Y} having the positive peak potential V1 as shown in FIG. 4. On the other hand, the plasma display device is set to the stop mode when no image signal is supplied. In this case, as shown in FIG. 6, the reset pulse RP_{Y} is not applied in the reset step R_{C} and, of course, no reset discharge is generated. That is, while no image signal is input, the reset discharge is stopped to reduce power consumption since there is no need to display images. Specifically, the reset discharge is not associated with image data and is a significant cause of reduction of the dark contrast. Accordingly, while no image signal is input, application of the reset pulse is stopped to satisfactorily realize a dark screen, which is displayed during a no-signal period in which no image signal is supplied, and also to increase the dark contrast.

However, if the duration in which application of the reset pulse is stopped continues, then the number of priming particles decreases as time passes and, even though an image signal is again input thereafter, there is a high probability of unstable discharges occurring, causing display failure.

Accordingly, in the invention, when the image signal changes from the state of the stop mode (i.e., the no-signal state) to the state in which an image signal is supplied, the reset mode setting unit 2 does not immediately return to the normal mode but instead returns to the normal mode after setting the reset mode to the boost mode during the predetermined second period T2 as shown in FIG. 2. Here, in the boost mode, the positive peak potential of the reset pulse RP_{Y} is set to a peak potential V2 higher than the peak potential V1 in the normal mode. That is, a reset discharge, which is stronger than a reset discharge that is generated in the reset step R_{C} in the normal mode, is generated in the reset step R_{C} in the boost mode. Accordingly, a reset discharge can be reliably generated even though a small number of priming particles are left in each discharge cell PC since the application of the reset pulse is stopped in the stop mode. In addition, in the boost mode, a reset discharge stronger than a reset discharge generated in the normal mode is generated to create a relatively large number of priming particles, thereby compensating for the deficiency of priming particles as described above. Therefore, the period during which the boost mode continues (i.e., the second period T2 as shown in FIG. 2) is set to be sufficiently long to overcome the deficiency of priming particles. Accordingly, after the boost continues during the period T2, each discharge mode can be stably generated and good display images can be provided without causing display failure. In addition, since discharges are continually and stably generated after the boost mode continues during the second period T2, the reset mode is switched from the boost mode to the normal mode to return the peak potential V2 of the reset pulse to the normal peak potential V1, thereby increasing black contrast.

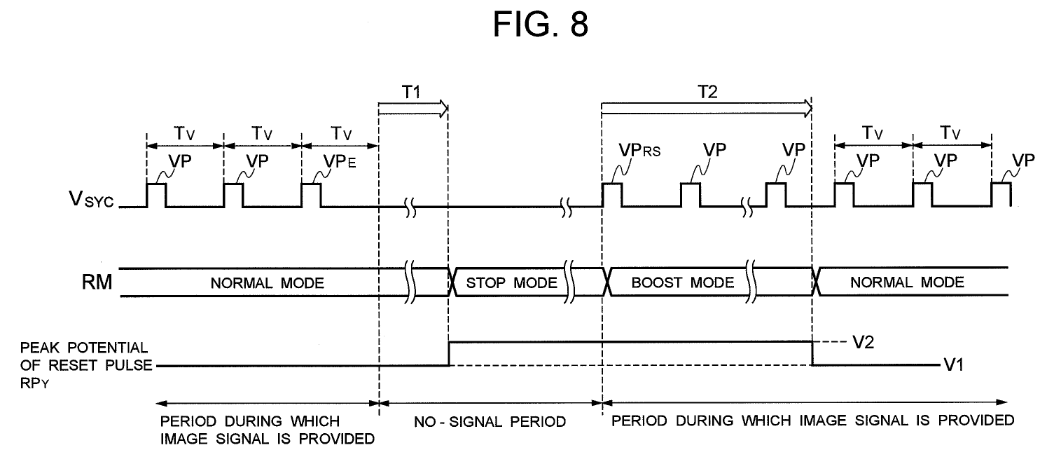

In the sequence shown in FIG. 2, a process for switching the peak potential of the reset pulse RP_{Y} from V1 to V2 (i.e., a process for providing a peak potential setting signal CV indicating a potential V2 to the variable DC power source VR) is performed at the time when the boost mode begins. However, as shown in FIG. 8, the process may not be performed at the time when the boost mode begins. That is, even when a peak potential setting signal CV indicating a potential V2 is supplied to the variable DC power source VR simultaneously with the beginning of the boost mode, the process may not be immediately reflected in the peak potential of the reset pulse RP_{Y} since the PDP 10 is a capacitive device and an unstable discharge may be generated while the process is not reflected in the peak potential. Therefore, as shown in FIG. 8, a process for switching the peak potential of the reset pulse RP_{Y} to the peak potential V2 is performed in the stop mode immediately before the boost mode so that a reset pulse RP_{Y} having the peak potential V2 can be generated simultaneously with the beginning of the boost mode. In the stop mode, no negative effects are exerted on display since the switching element SW of the reset pulse generation circuit as shown in FIG. 5 is fixed to an off state.

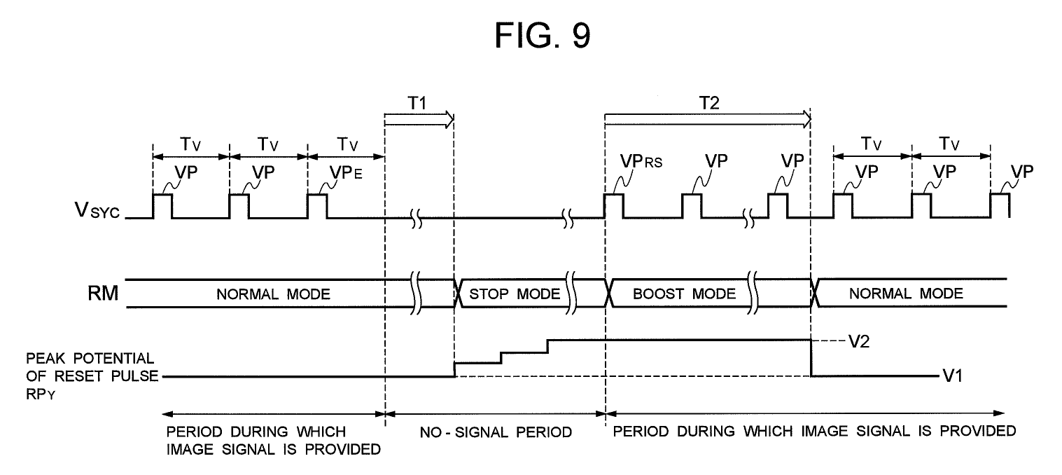

While the process for switching the peak potential of the reset pulse RP_{Y} from V1 to V2 is performed when the stop mode begins in the sequence shown in FIG. 8, a process for increasing the peak potential in a stepwise manner so that it reaches the final peak potential V2 immediately before the boost mode begins may be performed in the period of the stop mode as shown in FIG. 9. That is, performing a control operation causing a rapid change in the output voltage of the variable DC power source VR is highly likely to cause the variable DC power source VR to malfunction. Therefore, a control operation for increasing the output voltage of the variable DC power source VR from the potential V1 to V2 in a stepwise manner during the period of the stop mode is performed to prevent the variable DC power source VR from malfunctioning.

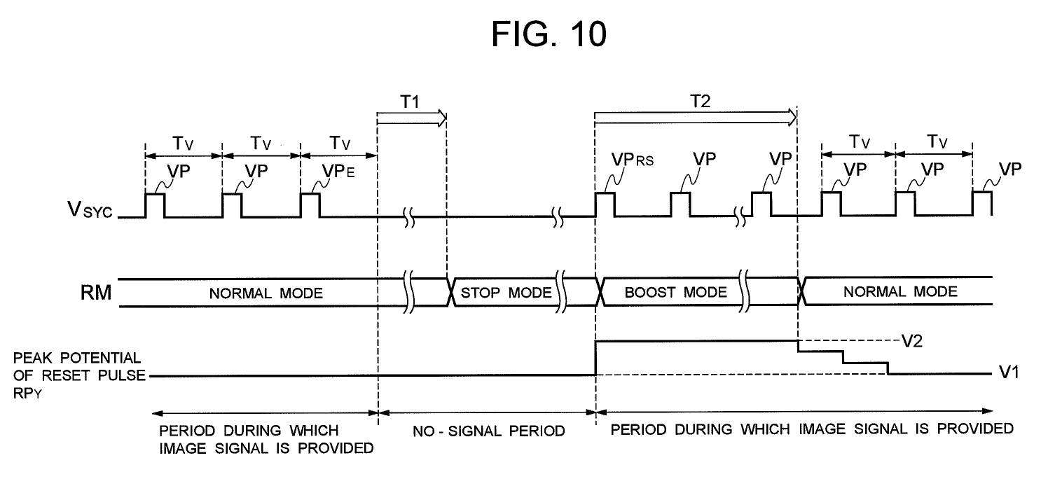

In addition, while the process for switching the peak potential of the reset pulse RP_{Y} from V2 to V1 simultaneously with the termination of the boost mode is performed in the sequence shown in FIG. 2, a process for reducing the peak potential from V2 to V1 in a stepwise manner may be performed in the period of the normal mode immediately after the boost mode terminates as shown in FIG. 10. If the peak potential of the reset pulse RP_{Y} is rapidly reduced from V2 to V1 immediately after the reset mode returns from the boost mode to the normal mode, the strength of a reset discharge also significantly changes and therefore luminance for black display significantly changes, thereby causing viewer discomfort. Therefore, as shown in FIG. 10, the peak potential of the reset pulse RP_{Y} is gradually reduced from V2 to V1 in a stepwise manner so that the change of luminance for black display is not visually remarkable.

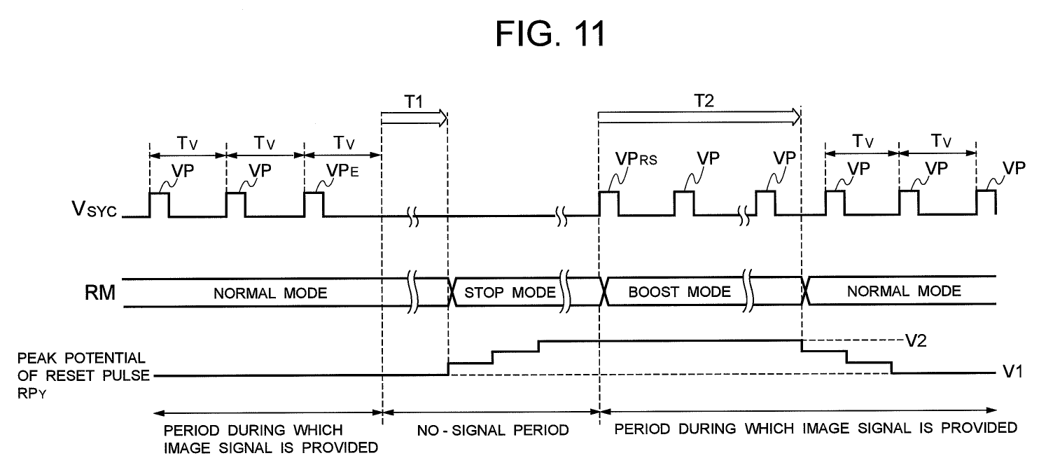

A sequence as shown in FIG. 11 employing both the technologies of FIGS. 9 and 10 may be used instead of the sequence as shown in FIG. 2.

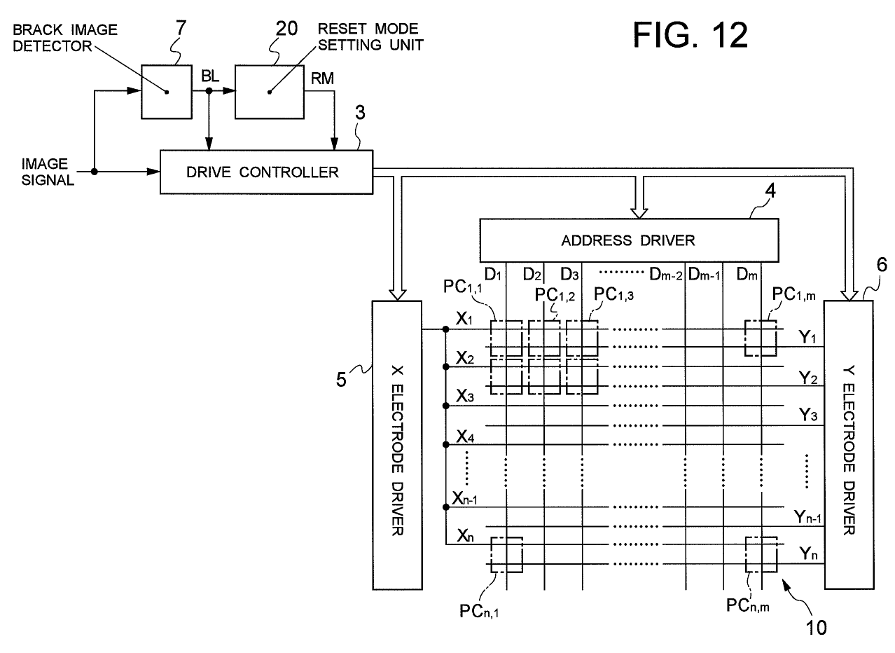

FIG. 12 illustrates another configuration of a plasma display device that drives a Plasma Display Panel (PDP) according to a drive method according to the invention.

The configuration of the plasma display device of FIG. 12 is identical to that of FIG. 1 with the only difference being that the synchronization detector 1 and the reset mode setting unit 2 shown in FIG. 1 are replaced with a black image detector 7 and a reset mode setting unit 20, respectively. Thus, the operation of the plasma display device shown in FIG. 12 will be described focusing on operations of the black image detector 7 and the reset mode setting unit 20.

The black image detector 7 generates a black image detection signal BL that has a logic level of “0” when an entirely-black image state, in which an entire image of one frame has a luminance level of “0”, is detected based on an input image signal. The black image detector 7 generates the black image detection signal BL that has a logic level of “1” when other states are detected based on an input image signal. The black image detector 7 supplies the black image detection signal BL to each of the reset mode setting unit 20 and the drive controller 3.

The reset mode setting unit 20 generates a reset mode signal RM indicating one of a “normal mode”, a “stop mode”, and a “boost mode” by performing processes described below based on the black image detection signal BL and supplies the generated reset mode signal RM to the drive controller 3.

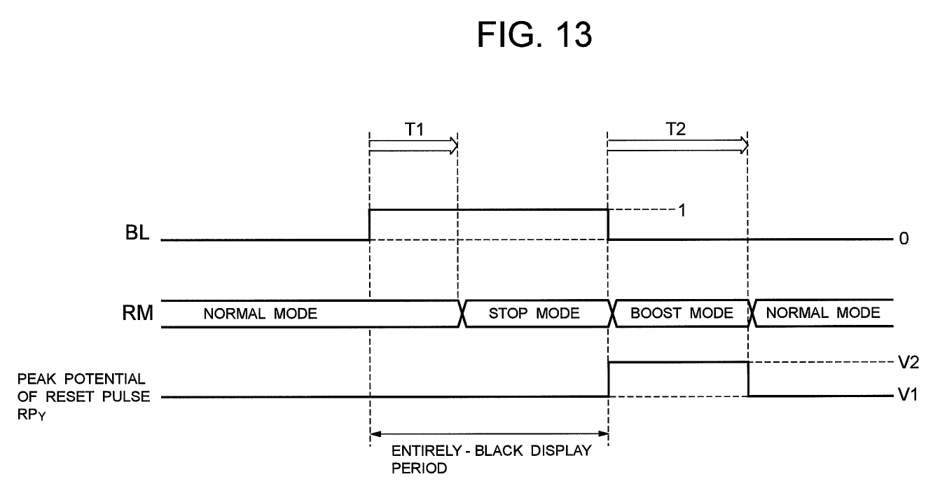

More specifically, the reset mode setting unit 2 supplies a reset mode signal RM indicating the normal mode to the drive controller 3 as shown in FIG. 13 in a period during which a black image detection signal BL having a logic level of “0” is received, i.e., in a period during which an image signal representing an image other than an entirely-black image is provided (or received).

When the provision of an image signal representing an entirely-black image is initiated in the normal mode, the reset mode setting unit 2 sequentially switches the reset mode from the normal mode to the stop mode and then from the stop mode to the boost mode according to a sequence as described below.

First, if the black image detection signal BL is kept in the state of a logic level of “1” indicating an entirely-black image until a predetermined first period T1 elapses after the black image detection signal BL change from the state of the logic level “0” to the state of the logic level of “1” as shown in FIG. 13, the reset mode setting unit 20 determines that the input image signal has changed to the entirely-black image state. At the time when the first period T1 elapses, the reset mode setting unit 20 supplies a reset mode signal RM indicating the stop mode instead of the normal mode to the drive controller 3. That is, in a period during which the input image signal is in the entirely-black image state, the reset mode setting unit 20 supplies a reset mode signal RM indicating the stop mode to the drive controller 3. Thereafter, as shown in FIG. 13, when the black image detection signal BL change from the state of the logic level “1” to the state of the logic level “0” indicating a normal image other than the entirely-black image, the reset mode setting unit 20 supplies a reset mode signal RM indicating the boost mode instead of the stop mode to the drive controller 3 during a predetermined second period T2. After the second period T2 elapses, the reset mode setting unit 20 supplies a reset mode signal RM indicating the normal mode to the drive controller 3. That is, when the input image signal returns from the entirely-black image state to a normal image state, the reset mode setting unit 20 does not immediately return to the normal mode but instead returns to the normal mode after setting the reset mode to the boost mode during the second period T2.

When the reset step R_{C} is performed every unit display period, the plasma display device shown in FIG. 12 is set to the normal mode during a period in which an image signal representing a normal image other than an entirely-black image is provided as shown in FIG. 13. Here, a reset discharge is generated in every discharge cell PC in response to the reset pulse RP_{Y} having the positive peak potential V1 as shown in FIG. 4. Thereafter, when an image signal carrying an entirely-black image is provided, the plasma display device is set to the stop mode. Here, as shown in FIG. 6, the reset pulse RP_{Y} is not applied in the reset step R_{C} and, of course, no reset discharge is generated. That is, while an image signal carrying an entirely-black image is provided, the reset discharge is stopped to reduce power consumption since there is no need to display images. Specifically, the reset discharge is not associated with image data and is a significant cause of reduction of the dark contrast. Accordingly, while an image signal carrying an entirely-black image is provided, application of the reset pulse is stopped to satisfactorily realize a dark screen and also to increase the dark contrast.

However, if the duration in which application of the reset pulse is stopped continues, then the number of priming particles decreases as time passes and, even though an image signal representing an image other than the entirely-black image is provided thereafter, there is a high probability of unstable discharges occurring, causing display failure.

Accordingly, in the invention, when the image signal changes from the state of the stop mode (i.e., the entirely-black image state) to the normal image state, the reset mode setting unit 20 does not immediately return to the normal mode but instead returns to the normal mode after maintaining the boost mode during the predetermined second period T2 as shown in FIG. 13. Here, in the boost mode, the positive peak potential of the reset pulse RP_{Y} is set to a peak potential V2 higher than the peak potential V1 in the normal mode. That is, a reset discharge, which is stronger than a reset discharge that is generated in the reset step R_{C} in the normal mode, is generated in the reset step R_{C} in the boost mode. Accordingly, a reset discharge can be reliably generated even though a small number of priming particles are left in each discharge cell PC since the application of the reset pulse is stopped in the stop mode. In addition, in the boost mode, a reset discharge stronger than a reset discharge generated in the normal mode is generated to create a relatively large number of priming particles, thereby compensating for the deficiency of priming particles as described above. Therefore, the period during which the boost mode continues (i.e., the second period T2 as shown in FIG. 13) is set to be sufficiently long to overcome the deficiency of priming particles. Accordingly, after the boost mode continues during the period T2, each discharge can be stably generated and good display images can be provided without causing display failure. In addition, since discharges are continually and stably generated after the boost mode continues during the second period T2, the reset mode is switched from the boost mode to the normal mode to return the peak potential V2 of the reset pulse to the normal peak potential V1, thereby increasing black contrast.

In the sequence shown in FIG. 13, a process for switching the peak potential of the reset pulse RP_{Y} from V1 to V2 (i.e., a process for providing a peak potential setting signal CV indicating a potential V2 to the variable DC power source VR) is performed at the time when the boost mode begins.

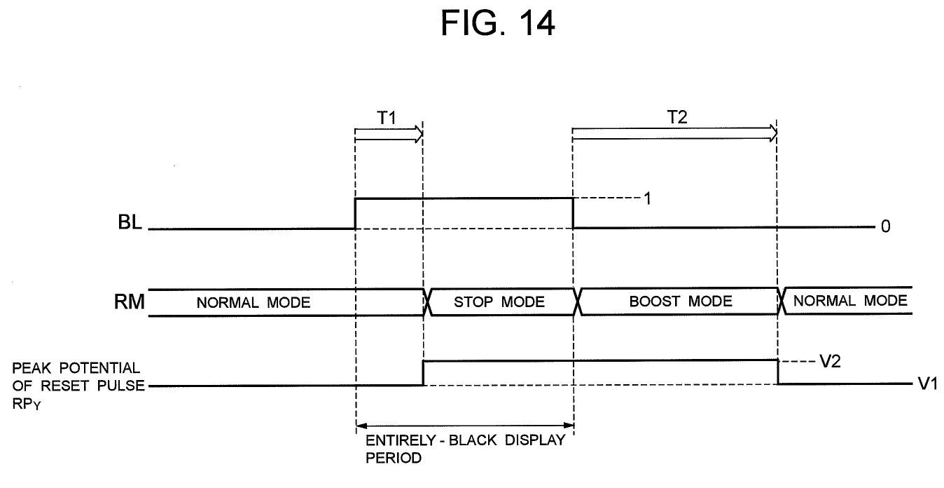

However, as shown in FIG. 14, the process may not be performed at the time when the boost mode begins. That is, even when a peak potential setting signal CV indicating a potential V2 is supplied to the variable DC power source VR simultaneously with the beginning of the boost mode, the process may not be immediately reflected in the peak potential of the reset pulse RP_{Y} since the PDP 10 is a capacitive device and an unstable discharge may be generated while the process is not reflected in the peak potential. Therefore, as shown in FIG. 14, a process for switching the peak potential of the reset pulse RP_{Y} to the peak potential V2 is performed in the stop mode immediately before the boost mode so that a reset pulse RP_{Y} having the peak potential V2 can be generated simultaneously with the beginning of the boost mode. In the stop mode, no negative effects are exerted on display since the switching element SW of the reset pulse generation circuit as shown in FIG. 5 is fixed to an off state.

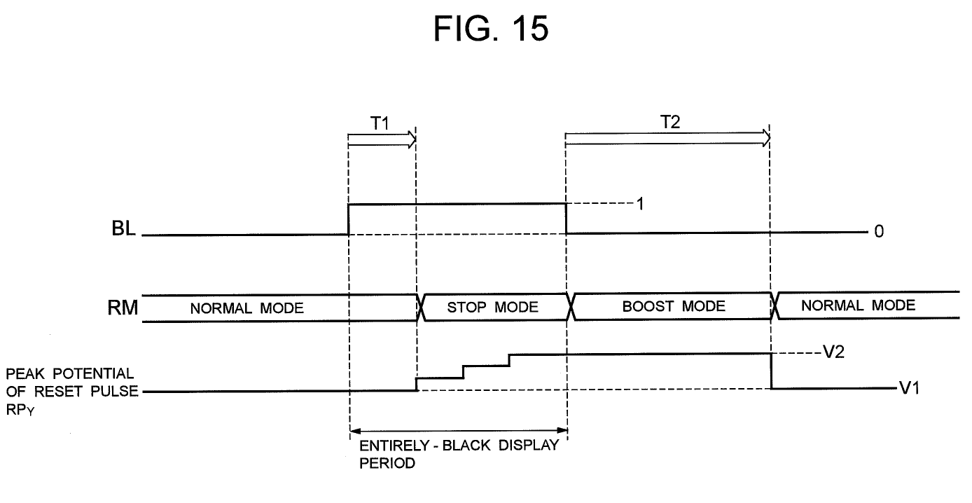

While the process for switching the peak potential of the reset pulse RP_{Y} from V1 to V2 is performed when the stop mode begins in the sequence shown in FIG. 14, a process for increasing the peak potential in a stepwise manner so that it reaches the final peak potential V2 immediately before the boost mode begins may be performed in the period of the stop mode as shown in FIG. 15. That is, performing a control operation causing a rapid change in the output voltage of the variable DC power source VR is highly likely to cause the variable DC power source VR to malfunction. Therefore, a control operation for increasing the output voltage of the variable DC power source VR from the potential V1 to V2 in a stepwise manner during the period of the stop mode is performed to prevent the variable DC power source VR from malfunctioning.

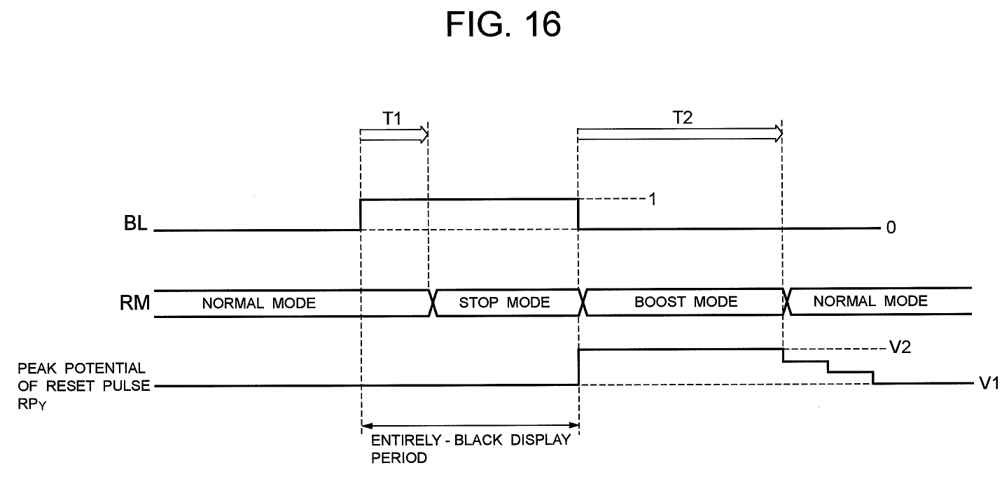

In addition, while the process for switching the peak potential of the reset pulse RP_{Y} from V2 to V1 simultaneously with the termination of the boost mode is performed in the sequence shown in FIG. 13, a process for reducing the peak potential from V2 to V1 in a stepwise manner may be performed in the period of the normal mode immediately after the boost mode terminates as shown in FIG. 16. If the peak potential of the reset pulse RP_{Y} is rapidly reduced from V2 to V1 immediately after the reset mode returns from the boost mode to the normal mode, the strength of a reset discharge also significantly changes and therefore luminance for black display significantly changes, thereby causing viewer discomfort. Therefore, as shown in FIG. 16, the peak potential of the reset pulse RP_{Y} is gradually reduced from V2 to V1 in a stepwise manner so that the change of luminance for black display is not visually remarkable.

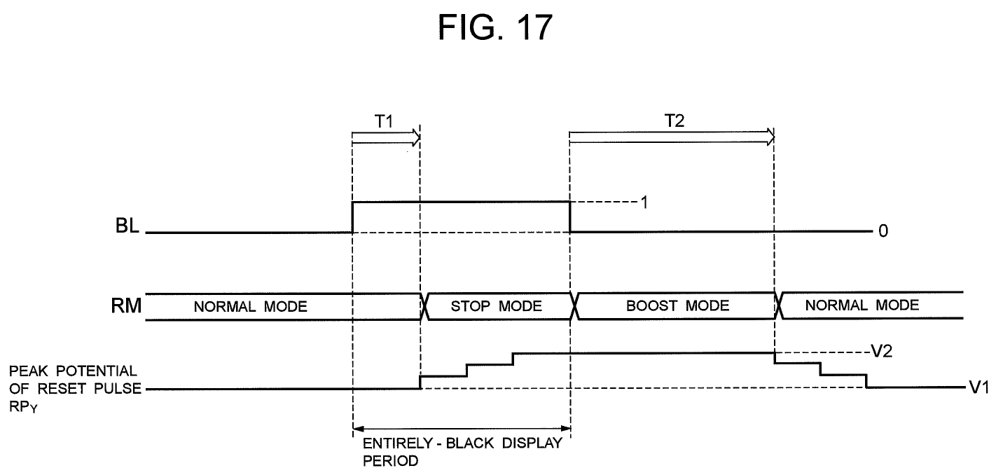

A sequence as shown in FIG. 17 employing both the technologies of FIGS. 15 and 16 may be used instead of the sequence as shown in FIG. 13.

In the plasma display device shown in FIGS. 1 and 12, the PDP 10 is driven using a selective erasure addressing method in which every discharge cell PC is initialized to a light-on mode in the reset step R_{C} of the subfield SF1 and each discharge cell PC selectively changes to a light-off mode in the addressing step W_{C} of each subfield SF as shown in FIGS. 3 and 4.

However, a selective write addressing method in which each discharge cell PC selectively changes to a light-on mode in the addressing step W_{C} of each subfield SF may also be employed to drive the PDP 10. In this case, a reset step R_{C} in which every discharge cell PC is initialized to a light-off mode may be set in a beginning portion of each subfield SF.

In addition, selective write addressing for selectively changing each discharge cell PC to a light-on mode may be performed in the addressing step W_{C} of at least one subfield SF in each 1-frame display unit while selective erasure addressing for selectively changing each discharge cell PC to a light-off mode may be performed in the addressing step W_{C} of each subfield other than the at least one subfield SF.

Further, specific frames (or fields) may be set such that the reset step R_{C} is not performed in each of the specific frames. That is, the reset step R_{C} may be performed in only one field (or frame) in each set of consecutive frames (or fields).

Furthermore, while the reset pulse RP_{Y} having a positive peak potential is used as a reset pulse that is applied to every discharge cell PC in the reset step R_{C} in the examples of FIGS. 4 and 7, a reset pulse having a negative peak potential may also be used. In this case, the absolute value of a negative peak potential V2 of a reset pulse that is applied in the reset step R_{C} in the boost mode is greater than the absolute value of a negative peak potential V1 of a reset pulse that is applied in the reset step R_{C} in the normal mode.

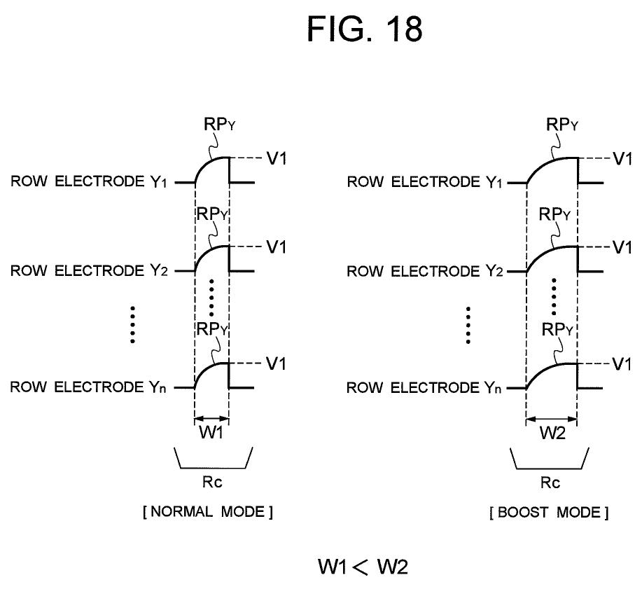

In addition, while the peak potential of the reset pulse RP_{Y} in the reset step R_{C} in the boost mode is set to be higher than that of the normal mode in the examples of FIGS. 4 and 7, the width of the reset pulse RP_{Y} in the reset step R_{C} in the boost mode may be set to be larger than that of the normal mode. For example, as shown in FIG. 18, a reset pulse RP_{Y} having a positive peak potential of “V1” and a pulse width of “W1” is applied to every row electrode Y in the normal mode. On the other hand, a reset pulse RP_{Y} having the positive peak potential “V1” and a pulse width of “W2” larger than “W1” is applied to every row electrode Y in the boost mode. That is, in the boost mode, the width of the reset pulse RP_{Y} is increased in order to increase the strength of the reset discharge.

Further, the shape of a waveform of the reset pulse RP_{Y} in a rising section thereof is not limited to those shown in FIGS. 4, 7, and 18 and may be, for example, a rectangular or lump shape.

Furthermore, while a drive pulse, whose peak level is increased in the boost mode, is exemplified by a reset pulse RP_{Y} in the above embodiments, such a drive pulse is not limited to the reset pulse RP_{Y} and various drive pulses such as the scan pulse SP, the pixel data pulse DP, and the sustain pulses IP_{X} and IP_{Y} may each be employed as the drive pulse whose peak level is increased in the boost mode.

In short, the application of each of the various drive pulses is stopped (i.e., the stop mode is activated) to reduce power consumption when the predetermined first period T1 elapses after the image signal enters a no-input state or an entirely-black image state. Thereafter, when the image signal changes to an input state or a state other than the entirely-black image state, the absolute value of a peak potential of each of the various drive pulses is increased or the pulse width of each of the various drive pulses is increased (i.e., the boost mode is activated) to increase the strength of discharge until the predetermined second period T2 elapses after the image signal change. That is, if the application of the drive pulse is stopped, priming particles are not created although they should be created as a discharge occurs. Therefore, as the period during which the application of the drive pulse is stopped increases, the number of priming particles remaining in the discharge cell decreases, thereby bringing the discharge cell into a state in which it is difficult to generate discharges. Thus, immediately after the image signal returns to an input state or a state other than the entirely-black image state, the absolute value of a peak potential of each of the various drive pulses or the pulse width of each of the various drive pulses is increased during the second period T2 so that discharges are generated even though the number of priming particles remaining in the discharge cell is small. Due to discharges generated during the second period T2, the number of priming particles is increased so that it is easy to generate discharges and thus the absolute value of the peak potential of each of the various drive pulses or the pulse width of each of the various drive pulses is returned to a normal absolute value or a normal pulse width (i.e., the normal mode is activated).

While both the first period T1 and the second period T2 shown in FIGS. 2, 8 to 11, and 13 to 17 are greater than zero, the first period T1 alone may also be zero.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. This application is based on a Japanese patent application No. 2008-115232 which is hereby incorporated by reference.

What is claimed is:

1. A method for driving a plasma display panel including a discharge cell corresponding to a pixel wherein a variety of drive pulses are applied to the plasma display panel to display an image represented by an input image signal, the method comprising:
applying a drive pulse having a first pulse waveform to said discharge cell in a period during which said image signal being input; and
stopping the application of the drive pulse when the input of said image signal is stopped and thereafter applying, when the input of said image signal is resumed, the drive pulse having a second pulse waveform different from said first pulse waveform to said discharge cell during a predetermined period.

2. The method according to claim 1, wherein an absolute value of a peak potential of the drive pulse having said second pulse waveform is greater than an absolute value of a peak potential of the drive pulse having said first pulse waveform.

3. The method according to claim 1, wherein a pulse width of the drive pulse having said second pulse waveform is greater than a pulse width of the drive pulse having said first pulse waveform.

4. The method according to claim 1, wherein the drive pulse is a reset pulse that is applied to initialize a state of said discharge cell.

5. The method according to claim 2, wherein, when the input of said image signal is stopped, a power source potential of the drive pulse is switched from a first potential corresponding to the peak potential of the drive pulse having said first pulse waveform to a second potential corresponding to the peak potential of the drive pulse having said second pulse waveform.

6. The method according to claim 5, wherein the power source potential of the drive pulse is switched such that the power source potential of the drive pulse is increased from said first potential to said second potential in a stepwise manner as time passes.

7. The method according to claim 1, wherein the pulse waveform of the drive pulse is switched from said second pulse waveform to said first pulse waveform when said predetermined period elapses after the input of said image signal is resumed after the input of said image signal is stopped.

8. The method according to claim 7, wherein the peak potential of the drive pulse is switched such that the peak potential of the drive pulse is decreased from the peak potential of said second pulse waveform to the peak potential of said first pulse waveform in a stepwise manner as time passes.

9. A method for driving a plasma display panel including a discharge cell corresponding to a pixel wherein a variety of drive pulses are applied to said plasma display panel to display an image represented by an input image signal, the method comprising:
applying a drive pulse having a first pulse waveform to said discharge cell in a period during which an image signal representing a normal image, other than an entirely-black image that is an image of one frame entirely having a luminance level of “0”, is supplied; and
stopping the application of the drive pulse when said image signal changes from a state representing said normal image to a state representing said entirely-black image and thereafter applying, when said image signal returns to the state representing said normal image, the drive pulse having a second pulse waveform different from said first pulse waveform to said discharge cell during a predetermined period.

10. The method according to claim 9, wherein an absolute value of a peak potential of the drive pulse having said second pulse waveform is greater than an absolute value of a peak potential of the drive pulse having said first pulse waveform.

11. The method according to claim 9, wherein a pulse width of the drive pulse having said second pulse waveform is greater than a pulse width of the drive pulse having said first pulse waveform.

12. The method according to claim 9, wherein the drive pulse is a reset pulse that is applied to initialize a state of said discharge cell.

13. The method according to claim 10, wherein, when said image signal is in the state representing said entirely-black image, a power source potential of the drive pulse is switched from a first potential corresponding to the peak potential of the drive pulse having said first pulse waveform to a second potential corresponding to the peak potential of the drive pulse having said second pulse waveform.

14. The method according to claim 13, wherein the power source potential of the drive pulse is switched such that the power source potential of the drive pulse is increased from said first potential to said second potential in a stepwise manner as time passes.

15. The method according to claim 9, wherein the pulse waveform of the drive pulse is switched from said second pulse waveform to said first pulse waveform when said predetermined period elapses after said image signal returns from the state representing said entirely-black image to the state representing said normal image.

16. The method according to claim 15, wherein the peak potential of the drive pulse is switched such that the peak potential of the drive pulse is decreased from the peak potential of said second pulse waveform to the peak potential of said first pulse waveform in a stepwise manner as time passes.
